(19) United States
(12) Patent Application Publication
(10) Pub. No.: US 2008/0251023 A1
(43) Pub. Date: Oct. 16, 2008

(54) Milking Farm

(75) Inventors: Uzi Birk, Huddinge (SE); Bjorn Johansson, Sodertalje (SE)

Correspondence Address: HARNESS, DICKEY & PIERCE, P.L.C., P.O. BOX 8910, RESTON, VA, 20195, US

(73) Assignee: DELAVAL HOLDING AB, Tumba (SE)

(21) Appl. No.: 11/663,463

(22) PCT Filed: Aug. 25, 2005
(86) PCT No.: PCT/SE05/01238

§ 371 Date: May 8, 2008

(30) Foreign Application Priority Data
Oct. 28, 2004 (SE) 0402612-6

(51) Int. Cl. A01J 5/00

(52) U.S. Cl. 119/14.03; 901/50

(57) ABSTRACT

The present invention relates to a milking system comprising a first and at least a second animal area cluster, wherein each of the animal area cluster comprises at least one animal area and each animal area comprises at least one milking point, and where the first and at least second animal area cluster are arranged side by side characterised in a tunnel connecting each milking point in the first and second animal area cluster.

### TECHNICAL FIELD

The present invention relates to a milking system. More specifically the present invention relates to a milking system for very large milking farms.

### BACKGROUND OF THE INVENTION

In large milking farms, where a large number of milking animals are kept and milked, significant problems arise with regards to logistics.

In such farms, animals may be divided into groups and kept in separate animal areas with separate milking points for milking, using either traditional milking equipment such as rotaries or herringbone stalls, or using modern highly automated robotic milking systems. In a large milking farm these milking points will thus be spread out over the farm. Connecting the milking points to a common milk recipient for conveying milk, and to a common control system may in these cases be a significant and expensive task. For robotic milking the demand increases further as washing liquid, hydraulic liquid, pressurised air etc must be supplied to each milking point.

U.S. Pat. No. 5,361,722 discloses a milking facility with a service alley. This document shows a service alley provided beneath the platform supporting the animals. The document is however completely silent with regards to problems relating to milking farms having milking points spread out over the milking farm area.

### SUMMARY OF THE INVENTION

It is a main object of the present invention to provide such a system that at least alleviates the above problems.

It is in this respect a particular object of the invention to provide such a system that reduces the cost and simplifies the installation and operation of milking farms comprising a large stock of milking animals.

These objects among others are, according to one aspect of the present invention, attained by a milking system comprising a first and at least a second animal area cluster each comprising at least one milking point, characterised in a tunnel connecting each milking point in the first and at least second animal area cluster.

By using a tunnel for connecting each milking point to necessary supplies and equipment, the drawing of cables and tubing is facilitated. In this way it is possible to avoid complicated tubing and wiring in the milking farm, which may prevent easy access to all parts of the farm as well as collect dust and dirt.

According to another variant of the invention the milking system comprises tubing for conveying milk to the milk recipient, tubing for conveying other media such as pressurised air, washing liquid, hydraulic liquid etc between control and support equipment and the milking points, as well as power lines and data signalling lines connecting each of the milking points to power and control equipment, and wherein the tubing, power lines and data signalling lines are provided in the tunnel.

By connecting the milking points to the milk recipient through the tunnel it is possible to reduce the distance of tubing connecting a milking point with a milk recipient, thus the milk need to be transported a shorter distance and will reach the milk recipient earlier. The drawing and maintenance of the milk tubes are easier to handle which of course is beneficial.

Other media than milk may also be conveyed by tubing through the tunnel. If the milking system utilises automatic milking robots, each robot need to be provided with a number of different means for operation, such as washing liquid, pressurised air, hydraulic fluid etc. All of these means may be supplied through tubing in the tunnel in an easy manner without cluttering the farm. Also electric power lines and data communication lines may beneficially be drawn through the tunnel. This will improve access to the lines for repair and maintenance.

According to a variant of the invention each animal area cluster comprises at least one animal area and each animal area comprises at least one milking point.

According to a variant of the invention the first and at least second animal area cluster are arranged side by side.

According to another variant of the invention the tunnel is provided with personnel transportation capabilities.

If the tunnel is made large enough it is also possible to use it for the personnel serving the milking farm. The personnel could use it for walking from one position to another without having to go through animal crowded areas, or take a long way round. It is even possible to provide the tunnel with transportation means, such as small electric cars etc.

According to another variant of the invention the animal area clusters and milking points are provided on a ground level in a milking farm and the tunnel is provided on a level lower than the ground level.

According to another variant of the invention the tunnel is provided beneath the animal area clusters.

By providing the tunnel right beneath the animal areas the tunnel provides a short-cut to the milking points. Thereby, tubing and wiring distance is reduced as well as walking distance.

According to another variant of the invention the tunnel comprises one connection, from the level of the tunnel to the ground level in the milking farm, for each animal area cluster.

By providing the tunnel with one access for each cluster personnel may easily access any animal area cluster from the control room or from any other animal area cluster through the tunnel.

According to another variant of the invention the tubing is provided in the tunnel with an inclination to support transportation of milk from the milking points to the milk recipient by means of gravitation.

Providing the tubing with an inclination makes it possible to transport the milk from the milking points to the milk recipient in a lenient way. If the tubing were drawn in the roof of the milking farm rather than in the tunnel, the milk had to be forced upwards. Since the tunnel is provided beneath the milking point it is possible to let the milk simply flow by the force of gravity towards the milk recipient. This results in a more lenient treatment of the milk which is beneficial for reducing free fatty acids.

According to another variant of the invention each of the animal area clusters comprises one animal area, and the milking point in the first animal area cluster is arranged at a distal position from the milking point in the second animal area cluster.

According to another variant of the invention at least two of the animal areas in one animal area cluster share a common milking point.

It is possible to let animals in two different animal areas to use the same milking point. In this case automatic gates goad the animals to return to the correct animal area after milking. It is also possible that one animal may be directed to the other milking area after milking. This may for instance be the case when a specific type of animals should be separated, for instance sick animals, animals needing medical treatment etc.

According to another variant of the invention each animal area in an animal area cluster is arranged so that the milking point in the animal area is provided as close as possible to the milking points of the other animal areas in the same animal area cluster.

It is beneficial to keep as many milking points as possible close together as this increase serviceability and maintainability. In this case several milking points may be serviced without the need for the serviceman to walk significant distances between service of each milking point. One way to define an animal area cluster could be as a group of animal areas where the corresponding milking points for the group are close together, or within a minimum distance.

The number of animal areas in one animal area cluster can be different depending on the layout of the animal area. However, as the number of animal areas increase, it will be increasingly difficult to find a way to have each corresponding milking point close to the other milking point, and at some point it will be impossible to have them close enough to define only one animal area cluster. At this time, one needs to divide the animal areas into at least two animal area clusters. It seems to be reasonable to have 2, 3, 4, 5, 6 or any number of animal areas for one animal area cluster.

According to another variant of the invention at least one of the animal area clusters comprises four animal areas arranged to have one corner, denoted milking corner, close to the milking corner of the other animal areas, and each milking point in each animal area in the animal cluster is provided in the milking corner.

Using four animal areas in each animal area cluster seem to be a natural number as the animal areas can be kept as squares, and the milking points provided in a corner close to the other animal areas.

According to another variant of the invention the milking point comprises at least one automatic milking robot provided to milk one animal at a time.

The invention seems specifically beneficial when automatic milking robots are employed, since these need significantly more resources, such as pressurized air, higher air flow requirements, washing liquid, detergents, hydraulic fluids etc, during their operation than traditional milking equipment, which in turn is more labour intense.

According to another variant of the invention the milking point comprises several automatic milking robots each provided to automatically milk one animal at a time.

If the animal area houses more milking animals than one milking robot is capable of handling it is conceivable to provide the milking point with two or more milking robots. The access to each robot is then controlled using automatic gates as is known in the state of the art.

According to another variant of the invention the milking point is a milking pit having several individual milking positions.

The invention is also applicable when using traditional milking equipment such as a herringbone stall.

Further characteristics of the invention and advantages thereof will be evident from the following detailed description of embodiments of the invention.

### BRIEF DESCRIPTION OF THE DRAWINGS

The present invention will become more fully understood from the detailed description of embodiments of the present invention given herein below and the accompanying FIGS. 1 to 3, which are given by way of illustration only, and thus are not limitative of the present invention.

FIG. 1 is a top view of a milking system according to one embodiment of the invention comprising three animal area clusters.

FIG. 2 is a top view of a milking system according to another embodiment of the invention where the control facilities are located at the long side of the animal areas.

FIG. 3 is a side view of the embodiment in FIG. 1 disclosing the tunnel connecting the milking points, the milk recipient and the control equipment.

### PREFERRED EMBODIMENTS

In the following description, for purposes of explanation and not limitation, specific details are set forth, such as particular techniques and applications in order to provide a thorough understanding of the present invention. However, it will be apparent to one skilled in the art that the present invention may be practiced in other embodiments that depart from these specific details. In other instances, detailed descriptions of well-known methods and apparatuses are omitted so as not to obscure the description of the present invention with unnecessary details.

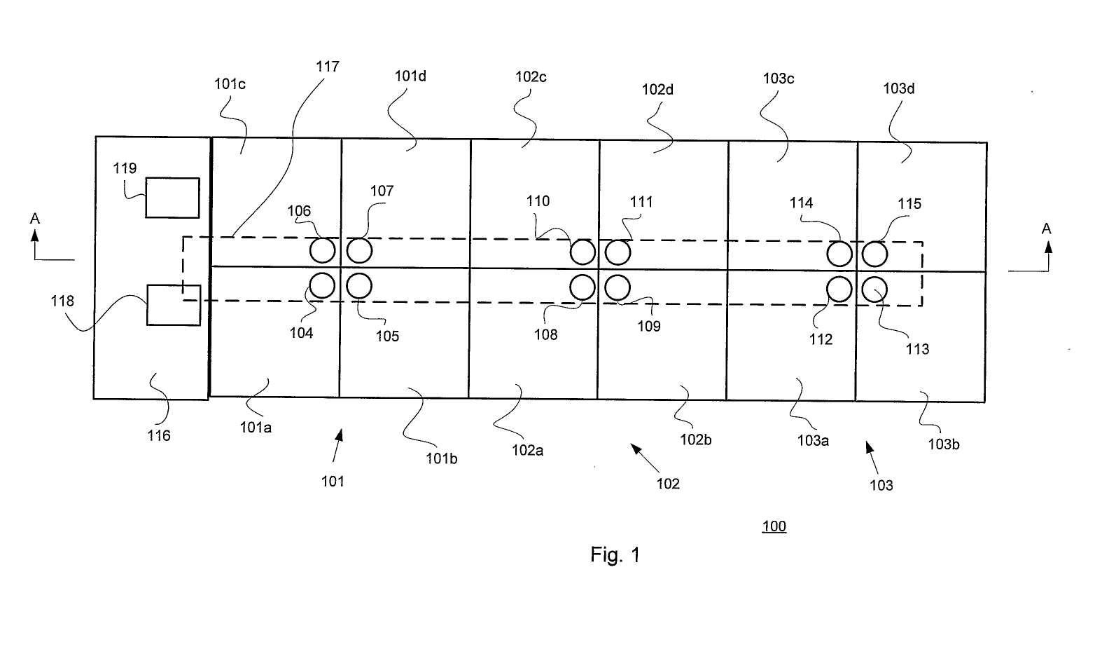

FIG. 1 is a top view of a milking system 100 according to one embodiment of the present invention. The milking system 100 comprises three animal area clusters denoted 101, 102 and 103 respectively. Each animal area cluster comprises four different animal areas, denoted a, b, c and d. Thus, the animal area cluster 101 comprises animal areas 101a, 101b, 101c and 101d. The first animal area cluster 101 comprises four milking points denoted 104, 105, 106 and 107, respectively, which are arranged in a respective animal area. Thus, the milking point 104 is arranged in animal area 101a etc. Likewise animal area cluster 102 comprises milking points 108, 109, 110 and 111 arranged in respective milking areas 102a, 102b, 102c and 102d, and finally, animal area cluster 103 comprises milking points 112, 113, 114 and 115 arranged in respective animal area. As can be seen from FIG. 1 the milking points in the milking system are grouped and the groups are spread out over the milking farm area.

Each animal area occupies a space necessary to host a specific number of animals, and the corresponding milking point is thus dimensioned to be capable to milk that number of milking animals. In that sense it could be said that each animal area in combination with the milking point is its own milking unit, in that it is dimensioned to host and milk a specific number of animals. It however lacks the means to store milk, that is it lacks its own milk recipient, as well as means necessary to provide, for instance electricity and other means necessary for operation of the milking point. These means are provided in a control room 116 or at another location.

Furthermore, each animal area comprises whatever means necessary to provide a suitable environment for the milking animals, such as feeding areas, resting areas, water etc, even though not shown in FIG. 1. The animal areas may further comprise gates etc, to goad animals between different animal areas or milking points if necessary.

The milking points may be any type of suitable milking equipment, such as a herringbone stall. However, the invention is particular suitable for the situation where automatic robotic milking is employed. In this case the milking point may be an automatic milking robot. It is known in the art to use more than one robot to milk a number of milking animals. This may also be applied in this invention in which case each milking point comprises more than one automatic milking robot, for instance two. Directing the animals in the specific animal area to either of the two milking robots are also known in the art and are preferably performed using automatic gates and animal identification equipment. If one milking robot is used in each animal area a corresponding number of animals are kept in that area, if two milking robots serves one animal area the number of animals can be doubled, but then the size of the animal area must also be adjusted. As an example, one milking robot may handle approximately 70 animals if they are milked three times a day.

It could also be possible to use only one milking point to milk animal from two animal areas. In that case the animals are led back to the correct animal area, which could be any of the animal areas, after milking, using automatic gates.

From a service and operation point of view it is beneficial to have all milking points close to each other. As can be seen from FIG. 1, the milking point in each milking area belonging to the same animal area cluster is positioned in a corner of the animal area, denoted milking corner, as close to the other milking points in that cluster as is possible. In this way, service and maintenance of the milking point equipment for all milking points in that cluster may be performed in a rational manner.

It is, however, not conceivable to have all 12 milking points of this embodiment in all animal area clusters close to each other since this would reduce access to the milking points. To ease drawing and maintenance of tubing and wires a tunnel 117 is provided beneath the animal areas under the milking points. The tunnel 117 connects the milking points in each animal area cluster with the control room 116. The control room comprises a milk recipient 118 and control equipment 119. Since the tunnel is provided with connections to the animal area level at each milking point, it is easy for personnel to reach each milking point without having the go through oftentimes crowded animal areas.

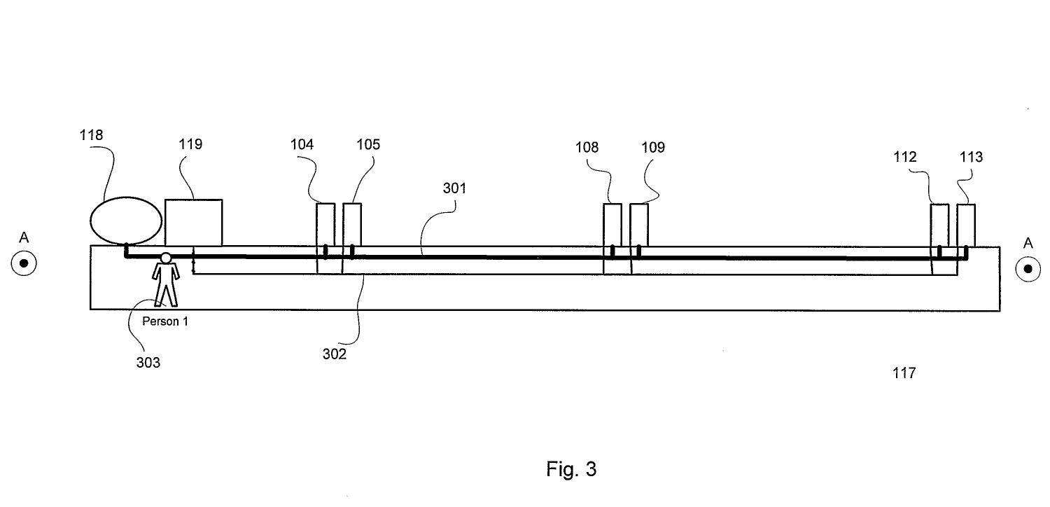

FIG. 3 is a side view of the milking system in FIG. 1 taken along the line A-A showing the tunnel 117. The same details are denoted with the same numerals as in FIG. 1. Thus, the milking points 104 and 105 in the first animal area cluster 101 are visible as are the milking points 108 and 109 in the second animal area cluster 102 and the milking points 112 and 113 in the third animal area cluster 103.

Tubing 301 connects each of the milking points 104 to 115 to the milk recipient 118 for conveying milk to the milk recipient 118. Since the tunnel is arranged below the milking points it is possible to utilize gravity to transport the milk to the milk recipient 118, by for instance provide the tubing 301 with a slight inclination towards the milk recipient 118. A second tubing and/or wiring 302 connect the control equipment 119 with all of the milking points 104 to 115. This may include electric power, data signaling, hydraulic fluid, washing liquid, pressurized air or anything needed for the operation of the milking equipment. As is shown in FIG. 3 the tunnel is large enough for a man 303 so that it may be used for walking or for transporting personnel from the control room to any milking point.

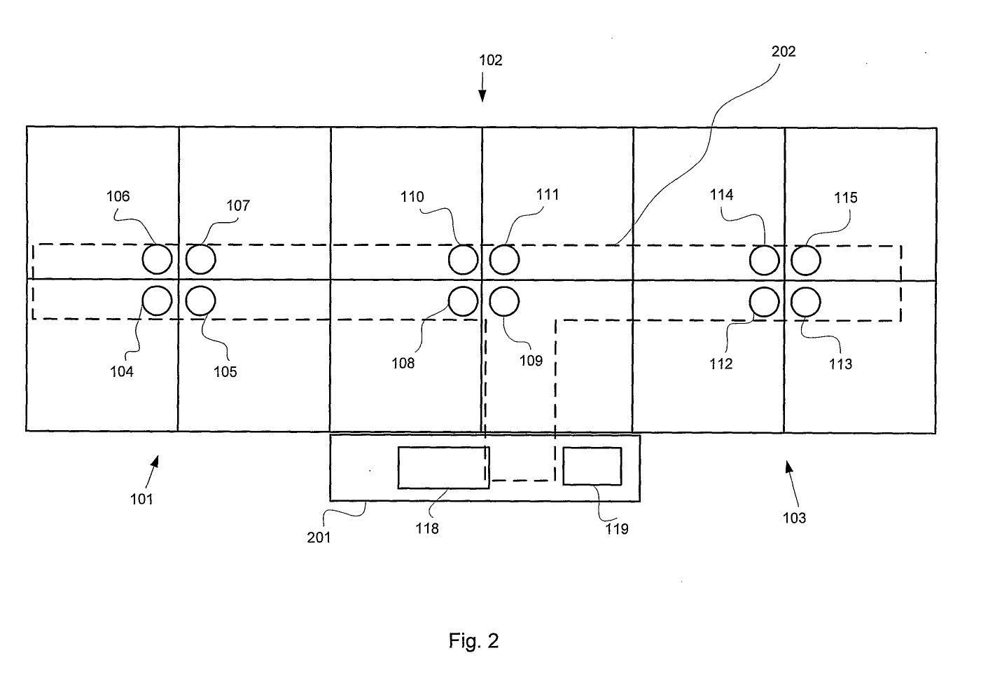

FIG. 2 is a top view of a milking system according to another embodiment of the invention. The same details are denoted with the same reference numerals as in FIG. 1. In this embodiment a control room 201 is positioned along the long side of animal area clusters 101, 102 and 103. Thus the tunnel 202 need to be modified in the a T-shape as seen from a top view so that the tunnel 202 may connect each milking point to the milk recipient 118 and control equipment 119.

It will be obvious that the invention may be varied in a plurality of ways. For instance may the animals be held at a first level and the tunnel provided at the ground level. Such variations are not to be regarded as a departure from the scope of the invention. All such modifications as would be obvious to one skilled in the art are intended to be included within the scope of the appended claims.

1. A milking system comprising a first and at least a second animal area cluster comprising at least one milking point, wherein,
a tunnel connecting each milking point in said first and second animal area cluster.

2. The milking system according to claim 1, comprising
tubing for conveying milk to a milk recipient,
tubing for conveying other media such as pressurised air, washing liquid, hydraulic liquid etc, from control and support equipment to each of said milking points and from said milking points to said control and support equipment,
power lines and data signalling lines connecting each of said milking points to power and control equipment, and wherein
said tubing, power lines and data signalling lines are provided in said tunnel.

3. The milking system according to claim, wherein
each animal area cluster comprises at least one animal area.

4. The milking system according to claim 1, wherein
said first and at least second animal area cluster are arranged side by side.

5. The milking system according to claim 2, wherein
said milk recipient is a milk tank, a dairy or a milk truck.

6. The milking system according to claim 1, wherein
said tunnel is provided with personnel transportation capabilities.

7. The milking system according to claim 1, wherein
said animal area clusters and milking points are provided on a ground level and said tunnel is provided on a level lower than said ground level.

8. The milking system according to claim 1, wherein
said tunnel is provided beneath said animal area clusters.

9. The milking system according to claim 7, wherein
said tunnel comprises one connection from the level of the tunnel to the ground level, for each animal area cluster.

10. The milking system according to claim 2, wherein
said tubing is provided in said tunnel with an inclination to support transportation of milk from the milking points to the milk recipient by means of gravitation.

11. The milking system according to claim 3, wherein
a milking point in an animal area of a first animal area cluster is arranged at a distal position from a milking point in an animal area of a second animal area cluster.

12. The milking system according to claim 3, wherein
at least one animal area cluster comprises at least two animal areas, and
at least two of said animal areas in said animal area cluster share a common milking point.

13. The milking system according to claim 3, wherein
each animal area in an animal area cluster is arranged so that the milking point in one animal area is provided as close as possible to the milking point of another animal area in the same animal area cluster.

14. The milking system according to claim 3, wherein
at least one of said animal area clusters comprises four animal areas arranged to have one corner, denoted milking corner, close to the milking corner of the other animal areas, and
each milking point in each animal area in said animal cluster is provided in said milking corner.

15. The milking system according to claim 1, wherein
said milking point comprises at least one automatic milking robot provided to milk one animal at a time.

16. The milking system according to claim 1, wherein
said milking point comprises several automatic milking robots each provided to automatically milk one animal at a time.

17. The milking system according to claim 1 wherein
said milking point is a milking pit having several individual milking positions, such as a herringbone parlour, a rotary parlour or a parallel parlour.

18. A milking system comprising a first and at least a second animal area cluster comprising at least one animal area, and wherein each animal area comprises at least one milking point wherein,
a tunnel connecting each milking point in said first and second animal area cluster,
tubing for conveying milk to a milk recipient,
tubing for conveying other media such as pressurised air, washing liquid, hydraulic liquid etc, from control and support equipment to each of said milking points and from said milking points to said control and support equipment,
power lines and data signalling lines connecting each of said milking points to power and control equipment, and wherein
said tubing, power lines and data signalling lines are provided in said tunnel.

19. A milking system comprising a first and at least a second animal area cluster comprising at least one animal area, and wherein each animal area comprises at least one milking point wherein,
a tunnel connecting each milking point in said first and second animal area cluster,
tubing for conveying milk to a milk recipient,
tubing for conveying other media such as pressurised air, washing liquid, hydraulic liquid etc, from control and support equipment to each of said milking points and from said milking points to said control and support equipment,
power lines and data signalling lines connecting each of said milking points to power and control equipment, and wherein
said tubing, power lines and data signalling lines are provided in said tunnel, and
each animal area in an animal area cluster is arranged so that the milking point in one animal area is provided as close as possible to the milking point of another animal area in the same animal area cluster.

20. A milking system comprising a first and at least a second animal area cluster comprising at least one animal area, wherein,
a tunnel connecting each milking point in said first and second animal area cluster, and wherein
each animal area in an animal area cluster is arranged so that the milking point in one animal area is provided as close as possible to the milking point of another animal area in the same animal area cluster.
